(19) United States
(12) Patent Application Publication
(10) Pub. No.: US 2022/0175071 A1
(43) Pub. Date: Jun. 9, 2022

(54) MULTILAYER BASE THAT CAN BE GLUED TO THE SKIN TO FORM SELF-ADHESIVE PROSTHESES FOR HAIR AND PROSTHETIC IMPLANTS THUS OBTAINED

(71) Applicant: SICURMATICA DI MASSIMILIANO DELLI, Calenzano (IT)

(72) Inventor: Massimiliano Delli, Calenzano (IT)

(21) Appl. No.: 17/603,508

(22) PCT Filed: Apr. 9, 2020
(86) PCT No.: PCT/IB2020/053401

§ 371 Date: Oct. 13, 2021

(30) Foreign Application Priority Data
Apr. 18, 2019 (IT) 102019000006060

(51) Int. Cl. A41G 3/00; B32B 27/30; B32B 27/40; B32B 27/08; B32B 1/00; B32B 27/20; C09J 7/30; C09J 133/08; C09J 175/04; C09J 11/04; C09J 11/06

(52) U.S. Cl. CPC A41G 3/0025; C09J 2400/20; B32B 27/308; B32B 27/40; B32B 27/08; B32B 1/00; B32B 27/20; C09J 7/30; C09J 133/08; C09J 175/04; C09J 11/04; C09J 11/06; B32B 2535/00; B32B 2264/1051; B32B 2264/107; C08J 2333/08; C09J 2475/00; C09J 2400/12; C09J 2400/16; A41G 3/0041

(57) ABSTRACT

A multilayer base designed to be bonded to the skin so as to form a prosthesis for self-adhesive hair, comprising an acrylic film with the addition of 0.1 to 3% of silver ions having the shape of the crown of the user's cranium and a polyurethane membrane onto which the hair is grafted attached to said acrylic film, characterized in that 0.1 to 3% by weight of micronized silver powder, 0.1 to 3% of nano-bio-ceramics and 0.1 to 3% of maslinic acid are added to the polyurethane polymer forming the membrane onto which the hair is grafted.

### CROSS-REFERENCE TO RELATED APPLICATIONS

This application claims priority to PCT International Application No. PCT/IB2020/053401 filed on Apr. 9, 2020, which application claims priority to Italian Patent Application No. 102019000006060 filed on Apr. 18, 2019, the disclosures of which are expressly incorporated herein by reference.

### STATEMENT RE: FEDERALLY SPONSORED RESEARCH/DEVELOPMENT

Not Applicable

### DESCRIPTION

The present invention relates to a multilayer base that can be glued to the skin to produce self-adhesive prostheses for hair, of the type described, for example, in Italian patent no. 102008901683189 (formerly, no. GE2008A000100), filed on Dec. 2, 2008 in the name of the same applicant of the present application with the title “Metodo di fabbricazione di un supporto multistrato incollabile sulla cute per la formazione di protesi autoadesive per capelli ed impianti protesici cosi ottenuti” (Method for making a multilayer base that can be glued to the skin to form self-adhesive prostheses for hair and prosthetic implants thus obtained).

As described in the above-mentioned prior patent, this method comprises:

a) forming a thin membrane consisting of a thermoformable acrylic compound designed to produce crowns having the shape of the user's cranium;

b) producing the actual prosthesis obtained by means of grafting hair onto a polyurethane membrane that is subsequently attached to the adhesive acrylic membrane.

The defect of this known method consisted in the fact that the hair, grafted onto the polyurethane membrane, rapidly lost its shine and elasticity.

According to the present invention it has been discovered that, by adding a mixture composed of 0.1% to 3% by weight of micronized powder of the hair on a membrane of nano-bio-ceramics and of 0.1% to 3% of maslinic acid to the polyurethane mixture forming the membrane onto which the hair is grafted, the polymer-keratin-water bond is modified providing continuous hydration to the hair shaft, which in this way maintains its elasticity and shine for a long period of time.

The polyurethane membrane thus modified is therefore able to alter the moisture absorption-desorption process in the hair grafted onto it.

A composition of the polyurethane membrane that conforms with the present invention could consist of the following (expressed in weight percentages):
micronized silver powder 1% by weight;
nano-bio-ceramics 1% by weight;
maslinic acid 1% by weight;
polyurethane glue added up to 100% parts by weight.

Both the formation of the acrylic base film and the formation of the polyurethane membrane onto which the hair is grafted can be implemented using well-known industrial methods, such as grafting of the hair onto the polyurethane membrane can be implemented using industrial methods.

1. A multilayer base designed to be bonded to the skin so as to form a prosthesis for self-adhesive hair, comprising:
an acrylic film with the addition of 0.1 to 3% of silver ions having the shape of the crown of the user's cranium;
a polyurethane membrane onto which the hair is grafted attached to said acrylic film, characterized in that 0.1 to 3% by weight of micronized silver powder, 0.1 to 3% of nano-bio-ceramics and 0.1 to 3% of maslinic acid are added to the polyurethane polymer forming the membrane onto which the hair is grafted.
